(19) United States
(12) Patent Application Publication
(10) Pub. No.: US 2025/0298864 A1
(43) Pub. Date: Sep. 25, 2025

(54) COMPUTATION ARRAY, COMPUTATION METHOD, APPARATUS AND DEVICE

(71) Applicant: Smarter Silicon (Shanghai) Technologies Co., Ltd., Shanghai (CN)

(72) Inventor: Bisheng WANG, Shanghai (CN)

(21) Appl. No.: 19/078,363

(22) Filed: Mar. 13, 2025

(30) Foreign Application Priority Data
Mar. 21, 2024 (CN) 202410331048.4

(51) Int. Cl. G06F 17/16; G06F 17/15

(52) U.S. Cl. CPC G06F 17/16; G06F 17/15

(57) ABSTRACT

The disclosure describes a computation array, a computation method, an apparatus and a device, where the computation array includes a plurality of computation units arranged in an array along a first direction, a second direction and a third direction. The first direction corresponds to a width direction of feature map data input into the computation array, the second direction corresponds to a height direction of the feature map data input to the computation array, and the third direction corresponds to a channel direction of the feature map data input to the computation array.

### CROSS-REFERENCE TO RELATED APPLICATION

This application claims priority to Chinese Patent Application No. 202410331048.4, filed on Mar. 21, 2024, the content of which is incorporated herein by reference in its entirety.

### TECHNICAL FIELD

The present disclosure generally relates to the field of neural networks, and in particular to a computation array, computation method, apparatus, and device.

### BACKGROUND

Convolutional computations account for about 70% of all computations in deep convolutional neural networks (CNN). Convolutional computations require a lot of data transfer, which takes a lot of time and energy. Convolutional computations have a lot of data reuse. A designed convolutional computation unit array (MAC array) needs to make full use of the data reuse of convolutional computations to reduce the amount of data transfer in the convolutional computation processes, thereby reducing the time and energy consumption and improving the energy efficiency of the MAC array.

The processing element (PE) array of the existing technology is unfolded on a plane and does not support simultaneous convolutional computations of multi-channel input feature maps. Instead, the existing PE array uses time-sharing to import input feature maps of different channels to complete the convolutional computation. Therefore, it is not efficient in multi-channel support, which affects the throughput.

### SUMMARY

In view of the foregoing, embodiments of the disclosure provide a computation array, a computation method, an apparatus and a device. The technical solution of the embodiments of the disclosure is implemented as follows.

In one aspect, embodiments of the disclosure provide a computation array, the computation array includes a plurality of computation units arranged in an array along a first direction, a second direction, and a third direction, where the first direction corresponds to a width direction of feature map data input to the computation array, the second direction corresponds to a height direction of the feature map data input to the computation array, and the third direction corresponds to a channel direction of the feature map data input to the computation array.

In another aspect, embodiments of the disclosure provide a computation method, which is executed by a computation array, and includes: obtaining feature map data and weight parameters; and inputting the feature map data and the weight parameters into the computation array for convolutional computation to obtain a computation result, wherein the computation array includes multiple computation units arranged in an array along a first direction, a second direction, and a third direction, the first direction corresponds to a width direction of feature map data input to the computation array, the second direction corresponds to a height direction of the feature map data input to the computation array, and the third direction corresponds to a channel direction of the feature map data input to the computation array.

In another aspect, embodiments of the disclosure provide a computation apparatus, the device includes an acquisition module, configured to obtain feature map data and weight parameters; and a computation module, configured to input the feature map data and the weight parameters into a computation array for convolutional computation to obtain a computation result, where the computation array includes the multiple computation units arranged in an array along a first direction, a second direction, and a third direction, the first direction corresponds to a width direction of feature map data input to the computation array, the second direction corresponds to a height direction of the feature map data input to the computation array, and the third direction corresponds to a channel direction of the feature map data input to the computation array.

In another aspect, embodiments of the disclosure provide an electronic device, including a memory and a processor, where the memory stores a computer program that may be executed on the processor, and the processor implements a computation method, the method including: obtaining feature map data and weight parameters; and inputting the feature map data and the weight parameters into the computation array for convolutional computation to obtain a computation result, wherein the computation array includes multiple computation units arranged in an array along a first direction, a second direction, and a third direction, the first direction corresponds to a width direction of feature map data input to the computation array, the second direction corresponds to a height direction of the feature map data input to the computation array, and the third direction corresponds to a channel direction of the feature map data input to the computation array.

In another aspect, embodiments of the disclosure provide a non-transitory computer-readable storage medium having a computer program stored thereon that, when being executed, causes at least one processor to perform a computation method disclosed elsewhere.

In another aspect, embodiments of the disclosure provide a computer program product, which includes a computer program, and when the computer program is executed by a processor, a computation method disclosed elsewhere is implemented.

Other features of the present disclosure and advantages thereof will become apparent from the following detailed description of exemplary embodiments of the present disclosure with reference to the accompanying drawings.

### BRIEF DESCRIPTION OF THE DRAWINGS

In order to more clearly illustrate the technical solution in the embodiments of the disclosure, the drawings essential for understanding the disclosed embodiments will be briefly described below. Apparently, the drawings described below are merely some embodiments of the disclosure. For a person skilled in the art, other drawings may be obtained based on the provided drawings without making creative efforts.

FIG. 1A is a data programming model for convolutional computation, according to some embodiments of the disclosure;

FIG. 1B is a schematic diagram of the overall architecture of a computation array, according to some embodiments of the disclosure;

FIG. 2A is a schematic diagram of loading weight parameters, according to some embodiments of the disclosure;

FIG. 2B is a schematic diagram of loading feature map data, according to some embodiments of the disclosure;

FIG. 3A is a schematic structural diagram of input feature buses of a single channel PE array, according to some embodiments of the disclosure;

FIG. 3B is a schematic diagram of data bit width corresponding to 16 channels, according to some embodiments of the disclosure;

FIG. 4A is a flow chart of a computation method, according to some embodiments of the disclosure;

FIG. 4B is a schematic diagram of loading 48-channel feature map data and 16 groups of 48-channel weight parameters, according to some embodiments of the disclosure;

FIG. 5 is a schematic diagram of a composition architecture of a computation apparatus, according to some embodiments of the disclosure; and

FIG. 6 is a schematic diagram of hardware components of an electronic device, according to some embodiments of the disclosure.

### DETAILED DESCRIPTION

In order to make the purpose, technical solution, and advantages of the embodiments of the disclosure clearer, the specific technical solution of the embodiments of the disclosure will be further described in detail below in conjunction with the drawings in the embodiments of the disclosure. The following embodiments are used to illustrate the disclosure, but are not used to limit the scope of the disclosure.

In the following description, reference is made to “some embodiments”, which describe a subset of all possible embodiments, but it is to be noted that “some embodiments” may be the same subset or different subsets of all possible embodiments and may be combined with each other without conflict.

In the following description, the terms “first/second/third” are merely used to distinguish similar objects and do not represent a specific ordering of the objects. It may be understood that “first/second/third” may be interchanged with a specific order or sequence where permitted, so that the embodiments of the disclosure described herein may be implemented in an order other than that illustrated or described herein.

Unless otherwise defined, technical and scientific terms used herein have the same meaning as those commonly understood by a person skilled in the art. The terms used herein are merely for the purpose of describing the embodiments of the disclosure and are not intended to limit the disclosure.

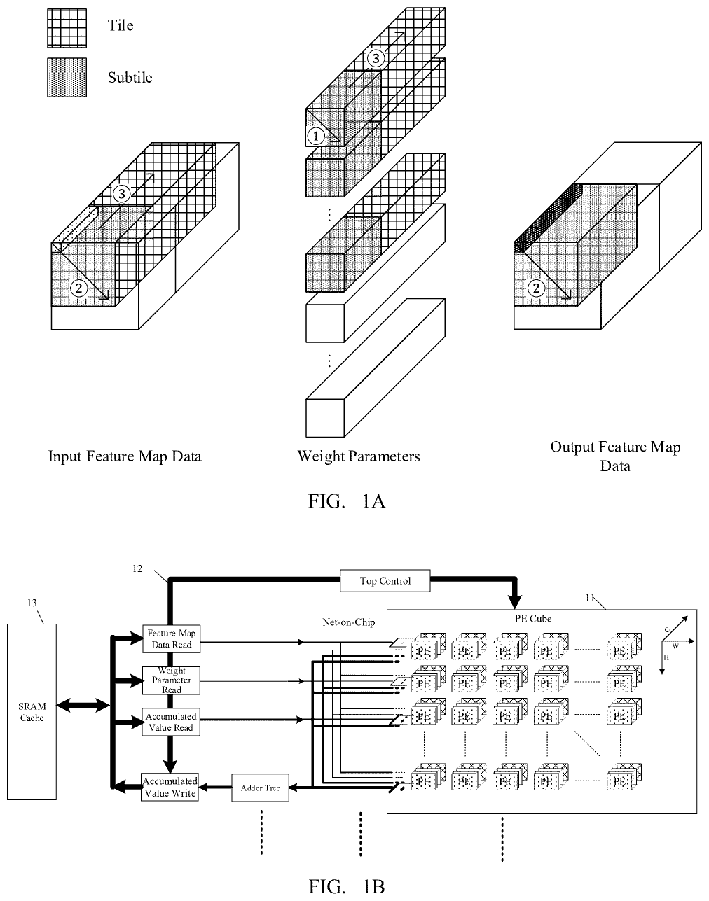

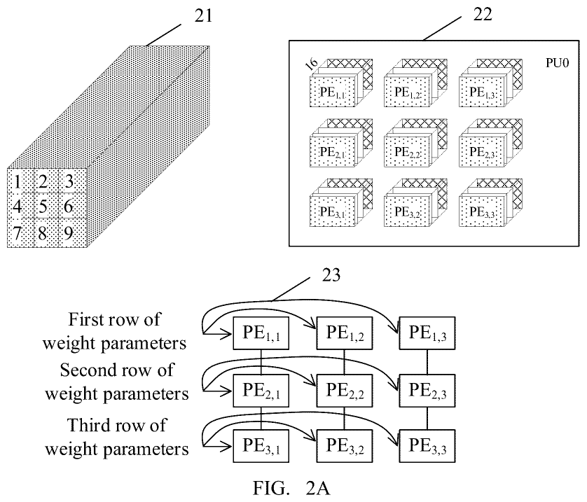

FIG. 1A is a data programming model for convolutional computation, according to some embodiments of the disclosure. As shown in FIG. 1A, the model includes input feature map data (or simply “input feature map”), weight parameters (or simply “weights”), and output feature map data (or simply “output feature map”).

In a convolutional computation, the input feature map data 11 is tiled by matching the actual MAC array size. In the specific scheduling execution, a tile is further divided into subtiles. A sub-tile feature map and multiple groups of filter weight parameters 13 complete the convolutional computation in the MAC array, and the partial sum of the output feature map data is temporarily stored in the buffer. Under the control of the scheduler, the convolutional computations of other subtiles are continued until the convolutional computation of all feature map data is completed. The corresponding partial sum data is accumulated to obtain the final output feature map data.

FIG. 1B is a schematic diagram of the overall architecture of a computation array, according to some embodiments of the disclosure. As shown in FIG. 1B, the overall architecture in the diagram includes a computation array (i.e., PE cube) 11, a control bus 12, and an SRAM cache 13.

In the PE cube 11, a plurality of computation units are arranged in an array along a first direction, a second direction, and a third direction.

The first direction corresponds to a width direction of the feature map data input to the computation array.

The second direction corresponds to a height direction of the feature map data input to the computation array.

The third direction corresponds to a channel direction of the feature map data input to the computation array.

Here, as shown in FIG. 1B, the computation array 11 is managed under a 3D architecture (i.e., PE cube), and its 3D array directions include a width direction (i.e., W direction), a height direction (i.e., H direction), and a channel direction (i.e., C direction) corresponding to the input of the feature map data.

The first direction, i.e., the W direction, corresponds to the width direction of the feature map data input to the computation array.

The second direction, i.e., the H direction, corresponds to the height direction of the feature map data input to the computation array.

The third direction, i.e., the C direction, corresponds to the channel direction of the feature map data input to the computation array.

In the implementation, a 2D directional array formed in the H and W directions supports the input in the recommendation system (RS) data stream direction, while an array along the C direction supports parallel inputting of data streams.

In some embodiments, in order to support C-channel parallel data input, assuming that the data width of a single PE is 8 bits and the array length in the C direction is 16 (i.e., 16 parallel channels), the data bit width of the net-on-chip (NoC) is 16*8=128 bits. At the same time, the SRAM also uses 128 bits as the storage bit width, so that a single clock (clk) may be configured to read and write data of 16 channels.

The control bus 12 includes a top control, a feature map data read (also called IFM RD), a weight parameter read (also called Filter RD), an accumulated value read (also called PSUM RD), an accumulated value write (also called PSUM WR) and an adder tree. The top control is configured to control the data (e.g., feature map data and weight parameters) written into the PE cube 11. The IFM RD is configured to read the feature map data. The Filter RD is configured to read the weight parameters of the filter. The PSUM RD is configured to read the accumulated value in the H direction. The PSUM WR is configured to write part of the obtained accumulated value into the SRAM cache 13. The adder tree is configured to connect the computation units in the C direction and accumulate the output data in the C direction.

The SRAM cache 13 is configured to store input feature map data and weight parameters, as well as output data after computation.

In the embodiments of the disclosure, the computation array includes a plurality of computation units that are arranged in an array along a first direction, a second direction, and a third direction, where the first direction corresponds to a width direction of feature map data input to the computation array, the second direction corresponds to a height direction of the feature map data input to the computation array, and the third direction corresponds to a channel direction of the feature map data input to the computation array. In this way, by arranging the computation units in the third direction, the feature map data and weight parameters to be calculated may be loaded into the computation units arranged in the third direction in parallel based on the channel direction, which effectively reduces the computation time and energy consumption overhead and improves the energy efficiency ratio of the computation array.

In some embodiments, each computation unit arranged in the N-th row in the first direction may correspondingly load all weight parameters of the N-th row in the first direction, where N is an integer greater than or equal to 1.

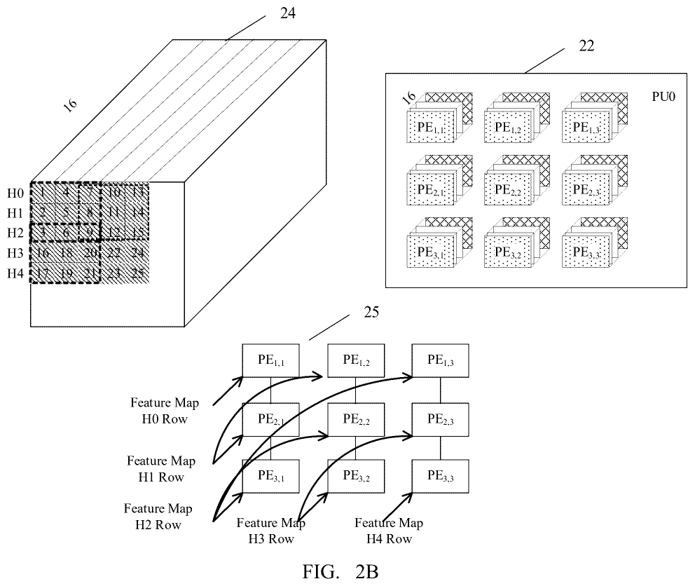

FIG. 2A is a schematic diagram of loading weight parameters, according to some embodiments of the disclosure. As shown in FIG. 2A, the schematic diagram includes a filter weight parameter matrix 21 with 16 channels, a computation array (i.e., PU0) 22, and a schematic sub-diagram 23 for the process of loading weight parameters.

The filter weight parameter matrix 21 is a 16-channel parameter matrix, where each channel has 9 filter parameters, which are marked as 1, 2, 3, 4, 5, 6, 7, 8, and 9 respectively.

The computation array 22 may be a computation array PU0 with 16 channels, where PU0 includes 16 two-dimensional computation subarrays arranged corresponding to the 16 channels, where each two-dimensional computation subarray includes the following 9 computation units (i.e., PEs), respectively identified as PE_{1,1}, PE_{1,2}, PE_{1,3}, PE_{2,1}, PE_{2,2}, PE_{2,3}, PE_{3,1}, PE_{3,2} and PE_{3,3}.

The process of loading weight parameters is schematically shown in the sub-diagram 23, which is used to illustrate the process of loading weight parameters of a two-dimensional computation subarray.

During the implementation process, as shown in sub-diagram 23 schematically illustrating the process of loading weight parameters, all weight parameters in the first row of the weight parameter matrix may be loaded into the three computation units PE_{1,1}, PE_{1,2} and PE_{1,3} in the first row respectively. All weight parameters in the second row may be loaded into the three computation units PE_{2,1}, PE_{2,2} and PE_{2,3} in the second row respectively. All weight parameters in the third row may be loaded into the three computation units PE_{3,1}, PE_{3,2} and PE_{3,3} in the third row respectively.

For example, the weight parameters of 16 channels may be loaded as shown in FIG. 2A. The weight parameters of the first row are loaded as follows: take the weight parameters labeled No. 1 in the first row (1*1*16) and send them to the first row (PE_{1,1}, PE_{1,2} and PE_{1,3}) of the 16 two-dimensional computation subarrays corresponding to PU0. Specifically, the parameters of channels 0 to 15 in the weight parameters are sent to the PE units in channels 0 to 15 in each two-dimensional computation subarray (PE_{1,1}, PE_{1,2} and PE_{1,3}). Then, the weight parameters labeled as No. 2 and No. 3 are loaded in turn, and the sending process is the same as that for No. 1. In this way, all weight parameters in the first row are sent to all PEs in the first row of the 16-channel computation arrays.

Here, the second row of weight parameters is loaded into all PEs in the second row of the 16-channel computation arrays, and the loading process is the same as the first row of weight parameters. The third row of weight parameters may be loaded into all PEs in the third row of the 16-channel computation arrays in the same way.

The computation units arranged in the first direction and the computation units arranged in the second direction may form a two-dimensional computation subarray. Each computation unit arranged in the M-th diagonal row on the diagonal rows of the two-dimensional computation subarray may correspondingly load all feature map data of the M-th row in the first direction, where M is an integer greater than or equal to 1.

FIG. 2B is a schematic diagram of loading feature map data according to some embodiments of the disclosure. As shown in FIG. 2B, the schematic diagram includes 16-channel feature map data 24, a computation array (i.e., PU0) 22, and a schematic sub-diagram 25 for the process of loading the feature map data.

The feature map data 24 is a 16-channel feature map data, and each channel has 25 filter parameters, which are marked as 1 to 25 respectively.

The process of loading feature map data is schematically shown in sub-diagram 25, which is used to illustrate the process of loading feature map data into a two-dimensional computation subarray.

During the implementation process, the feature map data of 16 channels may be loaded as shown in FIG. 2B. All feature map data in the feature map data row H0 may be loaded into the computation unit PE_{1,1}. All feature map data in the H1 row may be loaded into the computation units PE_{2,1} and PE_{1,2} respectively. All feature map data in the H2 row may be loaded into the computation units PE_{3,1}, PE_{2,2} and PE_{1,3} respectively. All feature map data in the H3 row may be loaded into the computation units PE_{3,2} and PE_{2,3} respectively. All feature map data in the feature map data row H4 may be loaded into the computation unit PE_{3,3}.

For example, the feature map data may be loaded as shown in the schematic diagram of the process of loading feature map data sub-diagram 25: first take the basic subtile (1*1*16) with the data labeled as No. 1 in the H0 row, and send it to PE_{1,1} corresponding to each channel of PU0 (PE_{1,1} has 16 identical PE computation units along the C channel), that is, the data of channels 0 to 15 are sent to the PE units in channels 0 to 15 in PE_{1,1}. Then send the feature data labeled as No. 4, No. 7, No. 10, and No. 13 in turn, and the sending process is the same as that for No. 1. In this way, all the feature data of this row of H0 are sent to PE_{1,1} corresponding to the 16 channels.

Load the feature data of row H1 into PE_{2,1} and PE_{1,2} in PU0, and the specific loading process is the same as H0.

Load the feature data of row H2 into PE_{3,1}, PE_{2,2} and PE_{1,3} in PU0.

Load the feature data of row H3 into PE_{3,2} and PE_{2,3} in PU0.

Load the feature data of row H4 into PE_{3,3} in PU0.

In the embodiments of the disclosure, each computation unit arranged in the N-th row of the first direction may be configured to load all weight parameters of the N-th row of the first direction. Computing units arranged in the first direction and computation units arranged in the second direction may form a two-dimensional computation subarray. Each computation unit arranged in the M-th diagonal row on the diagonal rows of the two-dimensional computation subarray may be configured to load all feature map data of the M-th row in the first direction. In this way, data reuse may be fully performed, memory access is reduced, and energy efficiency is improved.

In some embodiments, the K-th two-dimensional computation subarray arranged in the third direction may process the weight parameters and feature map data of the K-th channel, and the K two-dimensional computation subarrays may perform parallel computations, where K is an integer greater than or equal to 1.

In the implementation process, as shown in FIG. 2A, the 16 two-dimensional computation subarrays in PU0 may load the weight parameters of 16 channels. As shown in FIG. 2B, the 16 two-dimensional computation subarrays in PU0 may load the feature map data of 16 channels. After the weight parameters and feature map data are loaded into PU0, the 16 two-dimensional computation subarrays may operate in parallel.

In the embodiments of the disclosure, the K-th two-dimensional computation subarray arranged in the third direction may process the weight parameters and feature map data of the K-th channel, and the K two-dimensional computation subarrays may perform parallel computations. In this way, the computation efficiency of computing multi-channel weight parameters and feature map data using the computation array may be greatly improved.

In some embodiments, the computation units in a same row in the first direction are connected to a same first bus, and a second data switch is provided on each of the first buses to control whether to transmit weight parameters and feature map data to the first bus.

A first data switch is correspondingly disposed between each computation unit connected to a first bus and the first bus, for controlling whether the weight parameters and feature map data transmitted on the corresponding first bus are loaded into the computation unit.

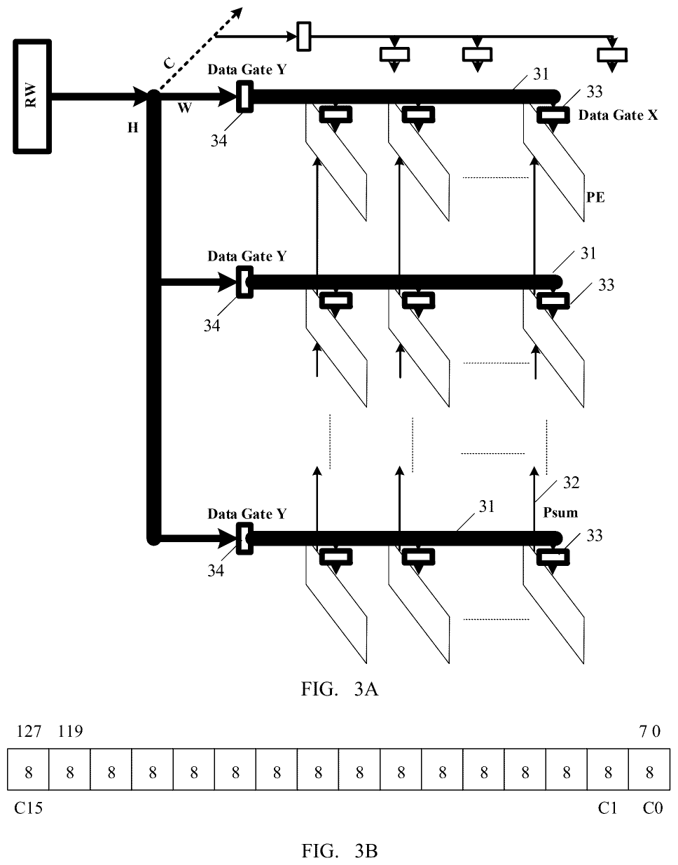

FIG. 3A is a schematic structural diagram of the input feature bus of a single-channel PE array, according to some embodiments of the disclosure. As shown in FIG. 3A, the structure schematic diagram of the bus includes: the computation units in a same row in the first direction (i.e., W direction) are connected to a same first bus 31, and the computation units in a same column in the second direction are connected to a same second bus (i.e., Pusm bus) 32. A second data switch (i.e., data gate Y) 34 is configured on each first bus 31 and a first data switch (i.e., data gate X) 33 is configured between each PE connected to the first bus 31 and the first bus 31.

Taking the input feature map data bus as an example, for a PE array in the 2D direction of a channel, and its bus layout is shown in FIG. 3A.

A rectangle in the figure represents a PE computation unit. A PE array row in the W direction is provided with data by the feature data bus in the W direction. Whether the data may pass through is controlled by the switch of the corresponding data gate X connected to the PE, and whether the feature data in the W direction may pass through is controlled by the switch of data gate Y. All data gates are determined by the configuration of the top control as shown in FIG. 1B. In this way, the data on the bus may be sent to any one or more PE computation units in the 2D PE array in the same channel through the switch of the data gates. Here, the top-level control refers to the module that uniformly completes the configuration of each data gate X or data gate Y on the PE array. Configuration means to set data gate X or data gate Y to 0 or 1. For example, if the data gate X on the first channel of the first row and the first column is set to 0, then this data gate X is closed and data cannot pass through this data gate X. Similarly, if this data gate X is set to 1, data may pass through this data gate X.

As shown in FIG. 3A, the loading of feature data of PE arrays of different channels may be achieved by controlling the first data switches 33 and the second data switches 34, so that the data to be loaded may be loaded into the corresponding computation units.

The selection of the bit width for the first bus and the bus is exemplified as follows. For instance, a bus with a bit width of 128 bits=16*8 bits, where each 8-bit unit is connected to channels C0 through C15 of a 2D PE array in ascending order from low to high. As shown in FIG. 3B, channels C0 to C15 are respectively connected to 8-bit wide buses. Specifically, channel C0 corresponds to data bits 0 to 7, channel C14 corresponds to data bits 112 to 119, and channel C15 corresponds to data bits 120 to 127. In some embodiments of the disclosure, other buses, such as those for filter weight parameters and Psum data, are laid out in the PE array in the same manner as the feature data buses.

In the embodiments of the disclosure, the computation units in the same row in the first direction are connected to a same first bus, and a second data switch is configured on each of the first buses to control whether weight parameters and feature map data are transmitted to the first bus. The computation units in the same column in the second direction are connected to a same second bus. A first data switch is configured between each computation unit connected to a first bus and the first bus to control whether the weight parameters and feature map data transmitted on the corresponding first bus are loaded into the computation unit. In this way, the feature map data or weight parameters may be loaded into the corresponding computation units by controlling the first data switches and the second data switches configured on the bus.

In some embodiments, the computation array further includes a second bus, connecting all computation units in each column in the second direction, for obtaining output data of all computation units in each column.

As shown in FIG. 3A, in the bus schematic structure diagram, the computation units in a same column in the second direction are connected to a same second bus (i.e., Pusm bus) 32, so that the output data of all computation units in each column may be obtained. In a 2D PE array in a same channel, there is no connection between PEs in the W direction, and there is a Psum bus 32 connection from bottom to top in the same column in the H direction to complete the accumulation of Psum on RS data stream.

In some embodiments, the computation array further includes an adder tree, connected to the computation units in the third direction, and used for accumulating the output data in the third direction.

As shown in FIG. 1B, an adder tree may be provided to connect the computation units in the third direction and accumulate the output data in the third direction.

When an adder tree bypass is set, output data of each channel in the third direction may be obtained respectively.

During the implementation process, for the Psum output bus from the PE array to the SRAM, the data of the PE array of C (16) channels (on the same H rows and W columns) may be obtained at one time. On one hand, the final cumulative sum (required for multi-channel convolutional computations) may be obtained through the adder tree and written into the SRAM. On the other hand, the adder tree may be bypassed to obtain the convolution and data of each channel in turn and write them into the corresponding SRAM, thereby supporting depth-wise convolutional computations.

In the embodiments of the disclosure, a second bus is connected to all the computation units in each column in the second direction, and is configured to obtain the output data of all the computation units in each column. The adder tree is connected to the computation units in the third direction, and is configured to accumulate the output data in the third direction. When the adder tree is bypassed, the output data of each channel in the third direction may be obtained respectively. In this way, the output data of all the computation units in each column may be obtained. On one hand, the final cumulative sum may be obtained through the adder tree, and on the other hand, the adder tree may be bypassed to obtain the convolution and data of each channel in turn.

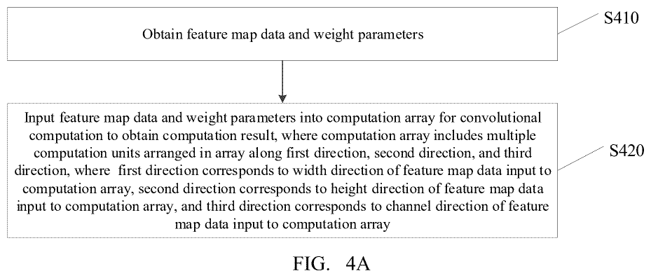

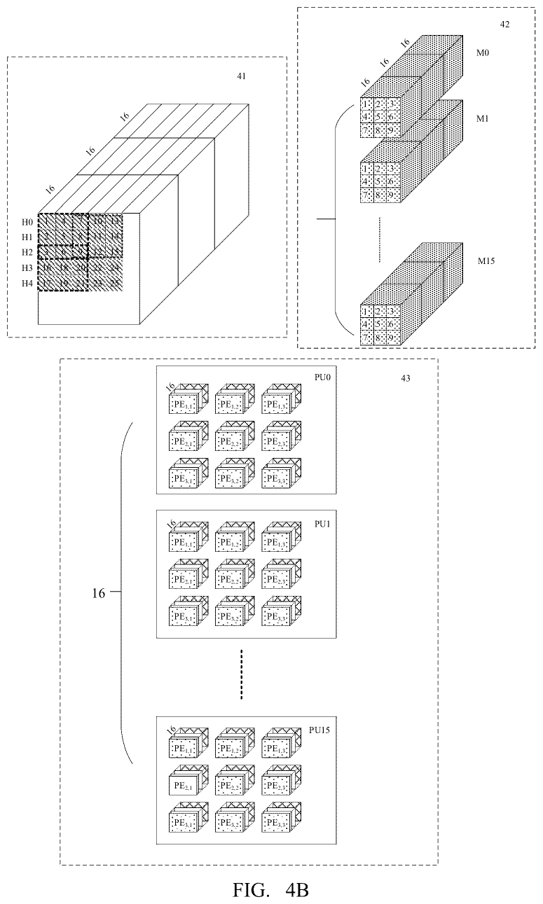

The disclosure provides a computation method, which is executed by a computation array. As shown in FIG. 4A, the method includes the following steps.

Step S410: Obtain feature map data and weight parameters.

Step S420: Input the feature map data and the weight parameters into the computation array for convolutional computation to obtain a computation result, where the computation array includes multiple computation units arranged in an array along a first direction, a second direction, and a third direction, where the first direction corresponds to a width direction of feature map data input to the computation array, the second direction corresponds to a height direction of the feature map data input to the computation array, and the third direction corresponds to a channel direction of the feature map data input to the computation array.

As shown in FIG. 1B, the computation array 11 is managed in a 3D architecture (i.e., PE cube), and its 3D array directions are composed of a width direction (i.e., W direction), a height direction (i.e., H direction), and a channel direction (i.e., C direction) corresponding to the input feature map data.

In the embodiments of the disclosure, the feature map data and the weight parameters are first obtained. Then the feature map data and the weight parameters are input into the computation array for convolutional computation to obtain the computation result. Here, since the computation array sets the computation units in the third direction, the feature map data and the weight parameters to be calculated may be loaded into the computation units in the third direction in parallel based on the channel direction, which effectively reduces the computation time and energy consumption overhead and improves the energy efficiency ratio of the computation array.

In some embodiments, the above step S420 of inputting the feature map data and the weight parameters into the computation array for convolutional computation to obtain a computation result may be implemented by the following steps.

Step 421: Obtain K groups of feature map data and weight parameters corresponding to K channels respectively, where K is an integer greater than or equal to 1.

Step 422: Load the K groups of feature map data and weight parameters in parallel to K two-dimensional computation subarrays of the computation array arranged in the third direction, where computation units arranged in the first direction and computation units arranged in the second direction may form a two-dimensional computation subarray.

Step 423: Perform convolutional computation on the feature map data and weight parameters loaded in each computation unit to obtain a computation result.

In the embodiments of the disclosure, firstly, K groups of feature map data and weight parameters corresponding to K channels are obtained. Then, the K groups of feature map data and weight parameters are loaded in parallel to the K two-dimensional computation subarrays of the computation array arranged in the third direction. Thereafter, the feature map data and weight parameters loaded in each computation unit are convolved to obtain the computation result. In this way, the K groups of feature map data and weight parameters may be loaded in parallel to the K two-dimensional computation subarrays of the computation array arranged in the third direction, effectively improving the efficiency of loading data.

In some embodiments, the above step 422 of loading K groups of the feature map data and weight parameters in parallel to the K two-dimensional computation subarrays of the computation array arranged in the third direction may be implemented by the following steps.

Step 4221: Load a K-th group of feature map data into the computation units in a K-th two-dimensional computation subarray based on the diagonal direction of the K-th two-dimensional computation subarray.

The process of loading feature map data is shown in the schematic sub-diagram 25 in FIG. 2B. All feature map data in the feature map data row H0 may be loaded into the computation unit PE_{1,1}. All feature map data in the H1 row may be loaded into the computation units PE_{2,1} and PE_{1,2} respectively. All feature map data in the H2 row may be loaded into the computation units PE_{3,1}, PE_{2,2} and PE_{1,3} respectively. All feature map data in the H3 row may be loaded into the computation units PE_{3,2} and PE_{2,3} respectively. All feature map data in the feature map data row H4 may be loaded into the computation unit PE_{3,3}.

For example, loading the feature map data of 16 channels may be shown in FIG. 2B: first take the basic subtile (1*1*16) with the data labeled as No. 1 in the H0 row, and send it to PE_{1,1} corresponding to each channel of PU0 (PE_{1,1} has 16 identical PE computation units along the C channel), that is, the data of channels 0 to 15 are sent to the PE units in channels 0 to 15 in PE_{1,1}. Then send the feature data labeled as No. 4, No. 7, No. 10, and No. 13 in turn, and the sending process is the same as that for No. 1. In this way, all the feature data of this row of H0 are sent to PE_{1,1} corresponding to the 16 channels.

Load the feature data of row H1 into PE_{2,1} and PE_{1,2} in PU0, and the specific loading process is the same as H0.

Load the feature data of row H2 into PE_{3,1}, PE_{2,2} and PE_{1,3} in PU0.

Load the feature data of row H3 into PE_{3,2} and PE_{2,3} in PU0.

Load the feature data of row H4 into PE_{3,3} in PU0.

Step 4222: Load a K-th group of weight parameters to the computation units in the K-th two-dimensional computation subarray based on the first direction of the K-th two-dimensional computation subarray, so as to load the K groups of feature map data and weight parameters in parallel to the K two-dimensional computation subarrays of the computation array arranged in the third direction.

As shown in the process schematic sub-diagram 23 of FIG. 2A, all weight parameters in the first row of the weight parameter matrix may be loaded into the three computation units PE_{1,1}, PE_{1,2} and PE_{1,3} arranged in the first row respectively. All weight parameters in the second row may be loaded into the three computation units PE_{2,1}, PE_{2,2} and PE_{2,3} arranged in the second row respectively. All weight parameters in the third row may be loaded into the three computation units PE_{3,1}, PE_{3,2} and PE_{3,3} arranged in the third row respectively.

For example, the weight parameters of 16 channels may be loaded as shown in FIG. 2A. The weight parameters of the first row are loaded as follows: take the weight parameters labeled as No. 1 in the first row (1*1*16) and send them to the first row (PE_{1,1}, PE_{1,2} and PE_{1,3}) of the 16 two-dimensional computation subarrays corresponding to PU0. That is, the parameters of channels 0 to 15 in the weight parameters are sent to the PE units in channels 0 to 15 in each two-dimensional computation subarray (PE_{1,1}, PE_{1,2} and PE_{1,3}). Then, the weight parameters labeled as No. 2 and No. 3 are loaded in turn, and the sending process is the same as that for No. 1. In this way, all weight parameters in the first row are sent to all PEs in the first row of the 16-channel computation arrays.

Here, the second row of weight parameters is loaded into all PEs in the second row of the 16-channel computation arrays, and the loading process is the same as the first row of weight parameters. The third row of weight parameters may be loaded into all PEs in the third row of the 16-channel computation arrays in the same way.

In the embodiments of the disclosure, the K-th group of feature map data is loaded into the computation units in the K-th two-dimensional computation subarray based on the diagonal direction of the K-th two-dimensional computation subarray. The K-th group of weight parameters is loaded into the computation units in the K-th two-dimensional computation subarray based on the first direction of the K-th two-dimensional computation subarray. In this way, it is possible to load the K groups of feature map data and weight parameters in parallel into the K two-dimensional computation subarrays of the computation array arranged in the third direction, which fully reuses data, reduces memory access, and improves energy efficiency.

FIG. 4B is a schematic diagram of loading 48-channel feature map data and 16 groups of 48-channel weight parameters, according to some embodiments of the disclosure. As shown in FIG. 4B, the schematic diagram includes 48-channel feature map data 41, 16 groups of 48-channel weight parameters 42, and a computation array 43, where one tile of input feature data 41 is H=5, W=5, Ci=48, the number of groups of filter weight parameter 42 is M=16, kernel=3*3, Ci=48, and one tile of the output feature data is E=3, F=3, Co=16. The size HWC of the 3D PE array 43 is: H=3, W=3, C=16, forming a PU. Assume there are 16 PUs, which support 8-bit int conv computation.

The programming format of feature data: NC₁HWC₀, with H=1, W=1, Co=16 as the smallest subtile (1*1*16) as the data unit, first access W columns of data by row (5*(1*1*16)), then access the next row of data in sequence, until the H rows of data (5*5*(1*1*16)) are accessed, thus completing the access of a subtile of size HWC₀ (5*5*16) (channel number 0˜15). Next, access the next subtile of size HWC₀ (5*5*16) (channel number 16˜31), and the specific process is the same as the first subtile. Similarly, access the last subtile of size HWC₀ (5*5*16) (channel number 31˜47). N is the batch of data, and C₁ is the value of Ci/C0.

The programming format of the weight parameters is similar to that of the feature data, which is MC₁HWC₀, where M is the number of filter groups. After accessing the first group of filter weights according to C₁HWC₀, the next group of filter weights is accessed in sequence.

The convolutional computation scheduling process is as follows.

Step A: Load feature map data.

Divide the feature map data (tile) 41 into three subtiles.

The first subtile: the number of channels is from 0 to 15, HW is 5*5, the smallest basic subtile is 1*1*16, and the labels are No. 1 to No. 25. The feature data is loaded as shown in FIG. 2B, that is, the basic subtile (1*1*16) with the data labeled as No. 1 in the H0 row is first taken, and sent to PE_{1,1} of PU0˜15 at the same time (PE_{1,1} has 16 identical PE computation units along the C channel), and the data of the 0˜15 channels of the basic subtile is sent to the PE units in the 0˜15 channels of PE_{1,1}, and the feature data between PUs is shared at the same time. Then the feature data labeled as No. 4, No. 7, No. 10, and No. 13 are sent in sequence, and the sending process is the same as that for No. 1. In this way, all the feature data of the H0 row are sent to PE_{1,1} of each PU.

Load the feature data of row H1 into PE_{2,1} and PE_{1,2} in each PU. The specific loading process is the same as H0. Load the feature data of row H2 into PE_{3,1}, PE_{2,2} and PE_{1,3} in each PU. Load the feature data of row H3 into PE_{3,2} and PE_{2,3} in each PU. Load the feature data of row H4 into PE_{3,3} in each PU.

Step B: load weight parameters.

The filter weight parameters 42 are loaded as shown in FIG. 2A: each set of filter weights is loaded into a corresponding PE array in a PU, that is, the 16 sets of filter weights M0-15 are loaded into the 16 PE arrays of PU0-15 respectively.

The process of loading the filter weights of M0 into the PE array of PU0 is as follows, and the loading process of other groups is similar.

Take the filter weight array 3*3*16 of the first 16 channels of M0.

Load the weight data of the first row: take the weight data labeled as No. 1 in the first row (1*1*16) and send it to the first row of the PE array of PU0 (i.e., PE_{1,1}, PE_{1,2}, PE_{1,3}, in FIG. 2A). Similarly, the weight data of channels 0 to 15 are sent to the PE units in channels 0 to 15 in each PE (i.e., PE_{1,1}, PE_{1,2}, PE_{1,3}). Then load the weight data labeled as No. 2 and No. 3 in turn, and the sending process is the same as that for No. 1. In this way, all the weight data in the first row are sent to all PEs in the first row of PU0.

The second row of weight data is loaded into all PEs in the second row of PU0. The specific loading process is the same as the first row of weight data. The third row of weight data is loaded into all PEs in the third row of PU0.

Similarly, the weight data of M1, M2, . . . , M15 are loaded into the PEs of PU1, PU2, . . . , PU15 respectively.

Step C: Complete the convolutional computation in the computation array and output the computation result.

The PE array of each PU completes its own convolutional computation, and the computation results are temporarily stored in the PE of each PU. If the PE has memory capacity issues, the partial sums in the PE may be accumulated by column first, and then transferred (the adder tree may be bypassed in this case) to the SRAM for storage.

As with the first subtile convolution, the convolutional computations of the second subtile (i.e., 16-31 channels) and the third subtile (i.e., 32-47 channels) are completed. The convolutional computation results of the three subtiles are first partially summed inside the respective PEs in each PU.

The PE computation results in each PU are then accumulated as follows.

Inside each PU, in the PE arrays of the same channel, in the same column, PE accumulates Psum from bottom to top, and outputs the Psum and value in the PE in the top row. In this way, the 16 channel outputs 16 convoluted parts and data corresponding to each channel, and then passes through the adder tree to obtain the final convolutional computation results of 48 channels. Each column of the PE array obtains a row of output feature data. In this example, a row contains 3 output feature data, with a total of three columns, forming 3*3 output feature data.

The output of each PU corresponds to the data of an output channel. There are 16 PUs in total, which output feature data of 16 channels.

In this way, the final convolution result is 3*3*16.

Based on the foregoing embodiments, embodiments of the disclosure provide a computation apparatus, which includes various modules, and each module includes various sub-modules. Each sub-module includes a unit, and may be implemented by a processor in an electronic device, and apparently may also be implemented by a specific logic circuit. In the implementation process, the processor may be a central processing unit (CPU), a microprocessor unit (MPU), a digital signal processor (DSP) or a field programmable gate array (FPGA), etc.

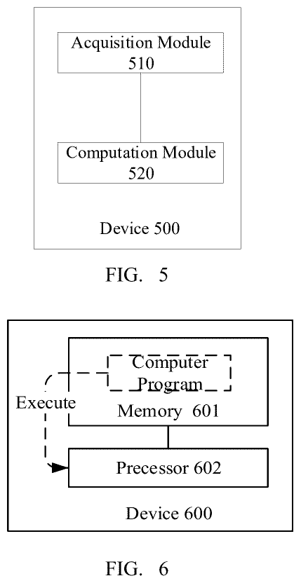

FIG. 5 is a schematic diagram of the composition architecture of a computation apparatus, according to some embodiments of the disclosure. As shown in FIG. 5, the apparatus 500 includes the following modules.

An acquisition module 510, which is configured to acquire feature map data and weight parameters.

A computation module 520, which is configured to input the feature map data and the weight parameters into a computation array for convolutional computation to obtain a computation result, where the computation array includes multiple computation units arranged in an array along a first direction, a second direction, and a third direction, where the first direction corresponds to a width direction of feature map data input to the computation array, the second direction corresponds to a height direction of the feature map data input to the computation array, and the third direction corresponds to a channel direction of the feature map data input to the computation array.

In some embodiments, the computation module 520 includes an acquisition submodule, a loading submodule and a convolutional computation submodule. The acquisition submodule is configured to acquire K groups of feature map data and weight parameters corresponding to K channels respectively, where K is an integer greater than or equal to 1. The loading submodule is configured to load the K groups of feature map data and weight parameters in parallel into K two-dimensional computation subarrays of the computation array arranged in the third direction, where computation units arranged in the first direction and computation units arranged in the second direction may for a two-dimensional computation subarray. The convolutional computation submodule is configured to perform a convolutional computation on the feature map data and weight parameters loaded in each computation unit to obtain a computation result.

In some embodiments, the loading submodule includes a first loading unit and a second loading unit, where the first loading unit is configured to load a K-th group of feature map data to the computation units in a K-th two-dimensional computation subarray based on a diagonal direction of a K-th two-dimensional computation subarray. The second loading unit is configured to load a K-th group of weight parameters to the computation units in the K-th two-dimensional computation subarray based on the first direction of the K-th two-dimensional computation subarray, so as to realize parallel loading of the K groups of feature map data and weight parameters to the K two-dimensional computation subarrays of the computation array arranged in the third direction.

The description of the above device embodiments is similar to the description of the above method embodiments, and has similar beneficial effects as the method embodiments. For technical details not disclosed in the device embodiments of the disclosure, refer to the description of the method embodiments of the disclosure for understanding.

It should be noted that in the embodiments of the disclosure, if the above described methods are implemented in the form of a software function module and sold or used as an independent product, they may also be stored in a computer-readable storage medium. Based on this understanding, the technical solution of the embodiments of the disclosure may be essentially or partly reflected in the form of a software product that contributes to the relevant technology. The computer software product is stored in a storage medium, including specific instructions to enable an electronic device (which may be a mobile phone, a tablet computer, a laptop computer, a desktop computer, etc.) to execute all or part of the methods described in each embodiment of the disclosure. The storage medium includes various media that may store program codes, such as a U disk, a mobile hard disk, a read-only memory (ROM), a magnetic disk, or an optical disk. In this way, the embodiments of the disclosure are not limited to any specific combination of hardware and software.

Correspondingly, embodiments of the disclosure provide a storage medium on which a computer program is stored. When the computer program is executed by a processor, the steps in the computation method provided in the above embodiments are implemented.

Correspondingly, embodiments of the disclosure provide an electronic device, and FIG. 6 is a schematic diagram of hardware components of the electronic device according to some embodiments of the disclosure. As shown in FIG. 6, the hardware components of the device 600 include a memory 601 and a processor 602, where the memory 601 stores a computer program that may be executed on the processor 602, and the processor 602 implements the steps in the computation methods provided in the above embodiments when executing the program.

The memory 601 is configured to store instructions and applications executable by the processor 602, and may also cache data to be processed or executed by the processor 602 and various modules in the electronic device 600 (e.g., image data, audio data, voice communication data, and video communication data), which may be implemented through flash memory or random access memory (RAM).

It should be noted here that the description of the above storage medium and device embodiments is similar to the description of the above method embodiments, and has similar beneficial effects as the method embodiments. For technical details not disclosed in the storage medium and device embodiments of the disclosure, refer to the description of the method embodiments of the disclosure for understanding.

It should be understood that “one embodiment” or “an embodiment” mentioned throughout the specification means that specific features, structures or features related to the embodiment are included in at least one embodiment of the disclosure. Therefore, “in one embodiment” or “in an embodiment” appearing throughout the specification does not necessarily refer to the same embodiment. In addition, these specific features, structures or features may be combined in one or more embodiments in any suitable manner. It should be understood that in various embodiments of the disclosure, the value of the sequence number of the above-mentioned processes does not mean the order of execution, and the execution order of each process should be determined by its function and internal logic, and should not constitute any limitation on the implementation process of the embodiments of the disclosure. The above-mentioned sequence numbers of the embodiments of the disclosure are only for description and do not represent the advantages and disadvantages of the embodiments.

It should be noted that, in this disclosure, the terms “include”, “comprises” or any other variations thereof are intended to cover non-exclusive inclusion, so that a process, method, article or apparatus including a series of elements includes not only those elements, but also other elements not explicitly listed, or also includes elements inherent to such process, method, article or apparatus. In the absence of further restrictions, an element defined by the sentence “comprises a . . . ” does not exclude the existence of other identical elements in the process, method, article or apparatus including the element.

In the specific embodiments provided in the disclosure, it should be understood that the disclosed devices and methods may be implemented in other ways. The device embodiments described above are only schematic. For example, the division of the units is only a logical function division. There may be other division methods in actual implementation, such as multiple units or components may be combined, or may be integrated into another system, or some features may be ignored or not executed. In addition, the coupling, direct coupling, or communication connection between the components shown or discussed may be through some interfaces, and the indirect coupling or communication connection of the devices or units may be electrical, mechanical or other forms.

The units described above as separate components may or may not be physically separated, and the components displayed as units may or may not be physical units. These components may be located in one place or distributed on multiple network units. Some or all of the units may be selected according to actual needs to achieve the purpose of the present disclosure.

In addition, all functional units in the embodiments of the disclosure may be integrated into one processing unit, or each unit may be a separate unit, or two or more units may be integrated into one unit. The integrated units may be implemented in the form of hardware or in the form of hardware plus software functional units.

A person skilled in the art may understand that all or part of the steps of implementing the above method embodiments may be completed by hardware related to program instructions, and the program instructions may be stored in a computer-readable storage medium. When executed, the program instructions execute the steps of the above method embodiments. The storage medium includes a mobile storage device, a read-only memory (ROM), a disk or an optical disk, and other media that may store program codes.

Alternatively, if the above-mentioned integrated unit of the disclosure is implemented in the form of a software function module and sold or used as an independent product, it may also be stored in a computer-readable storage medium. Based on this understanding, the technical solution of the embodiments of the disclosure may essentially, or in other words, the part that contributes to the relevant technology may be embodied in the form of a software product, and the computer software product is stored in a storage medium, including a number of instructions to enable an electronic device (which may be a mobile phone, a tablet computer, a laptop computer, a desktop computer, etc.) to execute all or part of the methods described in each embodiment of the disclosure. The storage medium includes various media that may store program codes, such as mobile storage devices, ROMs, magnetic disks, or optical disks.

The methods disclosed in specific method embodiments provided in the disclosure may be arbitrarily combined without conflict to obtain new method embodiments.

The features disclosed in specific device embodiments provided in the disclosure may be arbitrarily combined without conflict to obtain new device embodiments.

The features disclosed in specific method or device embodiments provided in the disclosure may be arbitrarily combined without conflict to obtain new method embodiments or device embodiments.

The foregoing description is just some embodiments of the disclosure, but the protection scope of the disclosure is not limited thereto. Any person skilled in the art may easily think of changes or substitutions within the technical scope disclosed in the disclosure, which should fall within the protection scope of the disclosure. Therefore, the protection scope of the disclosure should be based on the protection scope of the claims.

What is claimed is:

1. A computation array, comprising a plurality of computation units arranged in an array along a first direction, a second direction, and a third direction, wherein:
the first direction corresponds to a width direction of feature map data input to the computation array;
the second direction corresponds to a height direction of the feature map data input to the computation array; and
the third direction corresponds to a channel direction of the feature map data input to the computation array.

2. The computation array according to claim 1, wherein:
each computation unit arranged in a N-th row in the first direction is configured to load all weight parameters in the N-th row in the first direction correspondingly, where N is an integer greater than or equal to 1;
computation units arranged in the first direction and computation units arranged in the second direction form a two-dimensional computation subarray; and
each computation unit arranged in an M-th diagonal row on diagonal rows of the two-dimensional computation subarray is configured to load all feature map data of an M-th row in the first direction correspondingly, where M is an integer greater than or equal to 1.

3. The computation array according to claim 2, wherein:
a K-th two-dimensional computation subarray arranged in the third direction is configured to process weight parameters and feature map data of a K-th channel, and K two-dimensional computation subarrays are configured to perform parallel computations, where K is an integer greater than or equal to 1.

4. The computation array according to claim 1, wherein:
computation units in a same row in the first direction are connected to a same first bus, and a second data switch is provided on each first bus to control whether to transmit weight parameters and the feature map data to the first bus; and
a first data switch is correspondingly disposed between each computation unit connected to the first bus and the first bus, for controlling whether the weight parameters and the feature map data transmitted on the corresponding first bus are loaded into the computation unit.

5. The computation array according to claim 1, further comprising:
a second bus, connecting all computation units in each column in the second direction, for obtaining output data of all computation units in each column; and
an adder tree, connected to computation units in the third direction, and used for accumulating output data in the third direction,
wherein, when an adder tree bypass is configured, output data of each channel in the third direction is obtained respectively.

6. The computation array according to claim 5, further comprising:
a feature map data read, configured to read the feature map data;
a weight parameter read, configured to read weight parameters of a filter;
an accumulated read, configured to read an accumulated value in the height direction; and
an accumulated value write, configured to write part of the obtained accumulated value into a cache.

7. The computation array according to claim 6, wherein the accumulated value is obtained through the adder tree.

8. The computation array according to claim 1, further comprising a top control configured to control the feature map data and weight parameters written into each computation unit in the computation array.

9. A computation method, executed by a computation array, the method comprising:
obtaining feature map data and weight parameters; and
inputting the feature map data and the weight parameters into the computation array for convolutional computation to obtain a computation result, wherein the computation array includes multiple computation units arranged in an array along a first direction, a second direction, and a third direction, the first direction corresponds to a width direction of feature map data input to the computation array, the second direction corresponds to a height direction of the feature map data input to the computation array, and the third direction corresponds to a channel direction of the feature map data input to the computation array.

10. The method according to claim 9, wherein:
each computation unit arranged in a N-th row in the first direction is configured to load all weight parameters in the N-th row in the first direction correspondingly, where N is an integer greater than or equal to 1;
computation units arranged in the first direction and computation units arranged in the second direction form a two-dimensional computation subarray; and
each computation unit arranged in an M-th diagonal row on diagonal rows of the two-dimensional computation subarray is configured to load all feature map data of an M-th row in the first direction correspondingly, where M is an integer greater than or equal to 1.

11. The method according to claim 10, wherein inputting the feature map data and the weight parameters into the computation array for convolutional computation to obtain the computation result comprises:
obtaining K groups of feature map data and weight parameters corresponding to K channels respectively, where K is an integer greater than or equal to 1;
loading the K groups of feature map data and weight parameters in parallel to K two-dimensional computation subarrays of the computation array arranged in the third direction, wherein computation units arranged in the first direction and computation units arranged in the second direction form a two-dimensional computation subarray; and
convolving the feature map data and weight parameters loaded in each computation unit to obtain a computation result.

12. The method according to claim 11, wherein loading the K groups of feature map data and weight parameters in parallel into the K two-dimensional computation subarrays of the computation array arranged in the third direction comprises:
loading a K-th group of feature map data into computation units in a K-th two-dimensional computation subarray based on a diagonal direction of the K-th two-dimensional computation subarray; and
loading a K-th group of weight parameters into the computation units in the K-th two-dimensional computation subarray based on the first direction of the K-th two-dimensional computation subarray, so as to realize parallel loading of the K groups of feature map data and weight parameters into the K two-dimensional computation subarrays of the computation array arranged in the third direction.

13. An electronic device, including a memory and one or more processors, wherein the memory stores a computer program executable by the one or more processors, and when executing the computer program, the one or more processor are configured to perform:
obtaining feature map data and weight parameters; and
inputting the feature map data and the weight parameters into a computation array for convolutional computation to obtain a computation result, wherein the computation array includes multiple computation units arranged in an array along a first direction, a second direction, and a third direction, the first direction corresponds to a width direction of feature map data input to the computation array, the second direction corresponds to a height direction of the feature map data input to the computation array, and the third direction corresponds to a channel direction of the feature map data input to the computation array.

14. The electronic device according to claim 13, wherein:
each computation unit arranged in a N-th row in the first direction is configured to load all weight parameters in the N-th row in the first direction correspondingly, where N is an integer greater than or equal to 1;
computation units arranged in the first direction and computation units arranged in the second direction form a two-dimensional computation subarray; and
each computation unit arranged in an M-th diagonal row on diagonal rows of the two-dimensional computation subarray is configured to load all feature map data of an M-th row in the first direction correspondingly, where M is an integer greater than or equal to 1.

15. The electronic device according to claim 14, wherein the one or more processors are further configured to perform:
obtaining K groups of feature map data and weight parameters corresponding to K channels respectively, where K is an integer greater than or equal to 1;
loading the K groups of feature map data and weight parameters in parallel to K two-dimensional computation subarrays of the computation array arranged in the third direction, wherein computation units arranged in the first direction and computation units arranged in the second direction form a two-dimensional computation subarray; and
convolving the feature map data and weight parameters loaded in each computation unit to obtain a computation result.

16. The electronic device according to claim 15, wherein the one or more processors are further configured to perform:
loading a K-th group of feature map data into computation units in a K-th two-dimensional computation subarray based on a diagonal direction of the K-th two-dimensional computation subarray; and
loading a K-th group of weight parameters into the computation units in the K-th two-dimensional computation subarray based on the first direction of the K-th two-dimensional computation subarray, so as to realize parallel loading of the K groups of feature map data and weight parameters into the K two-dimensional computation subarrays of the computation array arranged in the third direction.

17. The electronic device according to claim 13, wherein:
computation units in a same row in the first direction are connected to a same first bus, and a second data switch is provided on each first bus to control whether to transmit weight parameters and the feature map data to the first bus; and
a first data switch is correspondingly disposed between each computation unit connected to the first bus and the first bus, for controlling whether the weight parameters and the feature map data transmitted on the corresponding first bus are loaded into the computation unit.

18. The electronic device according to claim 13, wherein the computation array further comprises:
a second bus, connecting all computation units in each column in the second direction, for obtaining output data of all computation units in each column; and
an adder tree, connected to computation units in the third direction, and used for accumulating output data in the third direction,
wherein, when an adder tree bypass is configured, output data of each channel in the third direction is obtained respectively.

19. The electronic device according to claim 13, wherein the computation array further includes a top control configured to control the feature map data and weight parameters written into each computation unit in the computation array.

20. The electronic device according to claim 13, wherein the computation array further comprises:
a feature map data read, configured to read the feature map data;
a weight parameter read, configured to read weight parameters of a filter;
an accumulated read, configured to read an accumulated value in the height direction; and
an accumulated value write, configured to write part of the obtained accumulated value into a cache.
